(19) United States
(12) Patent Application Publication
(10) Pub. No.: US 2026/0171888 A1
(43) Pub. Date: Jun. 18, 2026

(54) APPARATUS AND METHOD FOR OVERVOLTAGE PROTECTION, INVERTER AND ENERGY SYSTEM

(71) Applicant: Sungrow Power Supply Co., Ltd., Hefei (CN)

(72) Inventors: Jie Wu, Hefei (CN); Yongfu Wu, Hefei (CN); Bing Zhang, Hefei (CN)

(73) Assignee: Sungrow Power Supply Co., Ltd., Hefei (CN)

(21) Appl. No.: 19/417,709

(22) Filed: Dec. 12, 2025

(30) Foreign Application Priority Data
Dec. 18, 2024 (CN) 202411877736.7

(51) Int. Cl. H02M 1/00; H02M 1/084; H02M 1/092

(52) U.S. Cl. CPC H02M 1/0038; H02M 1/0845; H02M 1/092

(57) ABSTRACT

An apparatus and a method for overvoltage protection, an inverter, and an energy system. The apparatus comprises: a voltage clamping circuit, comprising a voltage clamping sub-circuit connecting a first phase line and a second phase line at an alternating-current side of an inverter circuit. The voltage clamping sub-circuit comprises an overvoltage suppressing circuit and a switching circuit. The switching circuit is configured to be turned on for forming a current path between first phase line and the second phase line via the overvoltage suppressing circuit, in response to a voltage of the first phase line being outside a voltage range. A breakdown voltage of the overvoltage suppressing circuit is within the voltage range.

This application claims the priority to Chinese Patent Application No. 202411877736.7, titled “APPARATUS AND METHOD FOR OVERVOLTAGE PROTECTION, INVERTER AND ENERGY SYSTEM”, filed on Dec. 18, 2024, with the China National Intellectual Property Administration, the content of which is incorporated herein by reference.

### FIELD

The present disclosure relates to the technical field of power electronics, and in particular to an apparatus and a method for overvoltage protection, an inverter, and an energy system.

### BACKGROUND

Rapid development of electrical technology is diversifying application scenarios of various electrical devices, and the electronic devices are subject to more frequent overvoltage issues. Overvoltage may result in maloperation of the electrical devices and even cause damage to the electrical devices.

Hence, effective overvoltage protection is particularly important to ensure safe and stable operation of the electrical devices.

### SUMMARY

An apparatus and a method for overvoltage protection, an inverter, and an energy system are provided according to embodiments of the present disclosure.

In a first aspect, an apparatus for overvoltage protection is provided according to an embodiment of the present disclosure. The apparatus comprises: a voltage clamping circuit, comprising a voltage clamping sub-circuit connecting a first phase line and a second phase line at an alternating-current side of an inverter circuit. The voltage clamping sub-circuit comprises an overvoltage suppressing circuit and a switching circuit. The switching circuit is configured to be turned on for forming a current path between the first phase line and the second phase line via the overvoltage suppressing circuit, in response to a voltage of the first phase line being outside a voltage range. A breakdown voltage of the overvoltage suppressing circuit is within the voltage range.

In a second aspect, a method for overvoltage protection is provided according to an embodiment of the present disclosure. The method is applicable to a voltage clamping circuit comprising a voltage clamping sub-circuit connecting a first phase line and a second phase line at an alternating-current side of an inverter circuit. The voltage clamping sub-circuit comprises an overvoltage suppressing circuit and a switching circuit. The method comprises: turning on the switching circuit to form a current path between the first phase line and the second phase line via the overvoltage suppressing circuit, in response to a voltage of a first phase line being outside a voltage range. A breakdown voltage of the overvoltage suppressing circuit is within the voltage range.

In a third aspect, an inverter is provided according to an embodiment of the present disclosure. The inverter comprises an inverter circuit, and an alternating-current side of the inverter circuit is connected to any foregoing apparatus for overvoltage protection.

In a fourth aspect, an energy system is provided according to an embodiment of the present disclosure. The energy system comprises an inverter circuit, and an alternating-current side of the inverter circuit is connected to any foregoing apparatus for overvoltage protection.

### BRIEF DESCRIPTION OF THE DRAWINGS

Hereinafter drawings to be applied in embodiments of the present disclosure or in related art are briefly described, in order to clarify illustration of technical solutions according to embodiments of the present disclosure or in related art. Apparently, the drawings in the following descriptions are only some embodiments of the present disclosure, and other drawings may be obtained by those skilled in the art based on the provided drawings without exerting creative efforts.

FIG. 1a is a schematic diagram of a voltage clamping circuit according to an embodiment of the present disclosure.

FIG. 1b is a schematic diagram of a voltage clamping circuit according to another embodiment of the present disclosure.

FIG. 1c is a schematic diagram of a voltage clamping circuit according to another embodiment of the present disclosure.

FIG. 1d is a schematic diagram of a voltage clamping circuit according to another embodiment of the present disclosure.

FIG. 2a is a schematic diagram of a voltage clamping circuit according to another embodiment of the present disclosure.

FIG. 2b is a schematic diagram of a voltage clamping circuit according to another embodiment of the present disclosure.

FIG. 3 is a schematic diagram of a voltage detecting circuit according to an embodiment of the present disclosure.

FIG. 4 is a schematic diagram of a signal processing circuit according to an embodiment of the present disclosure.

FIG. 5 is a schematic diagram of an isolating-driving circuit according to an embodiment of the present disclosure.

FIG. 6 is an apparatus for overvoltage protection according to an embodiment of the present disclosure.

FIG. 7a is a schematic diagram of an apparatus for overvoltage protection connected with a power grid according to an embodiment of the present disclosure.

FIG. 7b is a schematic diagram of an apparatus for overvoltage protection connected with a load according to an embodiment of the present disclosure.

FIG. 7c is a schematic diagram of an apparatus for overvoltage protection connected with a load according to another embodiment of the present disclosure.

FIG. 8a is a schematic diagram of an apparatus for overvoltage protection and an inverter that are separately arranged according to an embodiment of the present disclosure.

FIG. 8b is a schematic diagram of an inverter integrated with an apparatus for overvoltage protection according to an embodiment of the present disclosure.

FIG. 9a is a schematic diagram of an inverter connected with a power grid according to an embodiment of the present disclosure.

FIG. 9b is a schematic diagram of an inverter connected with a load according to an embodiment of the present disclosure.

FIG. 9c is a schematic diagram of an inverter connected with a load according to another embodiment of the present disclosure.

### DETAILED DESCRIPTION

Hereinafter technical solutions in embodiments of the present disclosure are described clearly and completely in conjunction with the drawings in embodiments of the present closure. Apparently, the embodiments described are only some rather than all of the embodiments of the present disclosure.

Herein the terms such as “first” and “second” are intended for distinguishing objects and do not indicate or imply relative importance or a quantity of objects. The objects modified by “first” and “second” may have a quantity of one or more. Herein “multiple” refers to two or more unless explicitly defined otherwise.

Overvoltage is a critical issue and affects the stability and safety of electrical devices. Generally, transient events in power systems, such as a lightning strike, a sudden change in load, or a switching operations, would induce overvoltage, and an electrical device would be subject to a voltage stress greater than a rated voltage range. When not suppressed timely or efficiently, the overvoltage may cause maloperation, off-grid, and even hardware damage to the electrical device. Hence, it is necessary to provide a reliable apparatus for overvoltage protection in the power grid to ensure safe and stable operation of electrical devices and an electric system.

Overvoltage protection may be implemented using an overvoltage suppression component such as a metal oxide varistor (MOV) or a gas discharge tube (GDT). Some overvoltage suppression components are subject to a large error in protection threshold, long response time, or limited power capability, which makes it difficult to provide stable and reliable protection in practical applications. For example, the error in breakdown voltage of varistor may be as large as tens or even hundreds of volts. Such large error may cause a failure in accurate clamp of voltage peaks, especially in a scenario having high precision requirements. The poor clamping effect makes it difficult to avoid overvoltage damage to the devices. Herein the breakdown voltage may refer to a minimum voltage at which the overvoltage suppression component starts to operate in a conducting state, for example, the varistor voltage of the MOV or the spark-over voltage of the GDT.

An apparatus for overvoltage protection is provided according to embodiments of the present disclosure. The apparatus for overvoltage protection comprises a voltage clamping sub-circuit connecting different phase lines at an alternating-current (AC) side of an inverter circuit. The voltage clamping sub-circuit comprises an overvoltage suppressing circuit and a switching circuit. The switching circuit is configured to be turned on to provide a low impedance path between the overvoltage suppressing circuit and one of the phase lines, in response to a voltage of such phase line being outside a predetermined voltage range. Hence, excess power is discharged toward other phase line(s), and overvoltage is effectively suppressed.

In the above apparatus, the switching circuit and the overvoltage suppressing circuit are connected in series in the current path between two different phase lines, and the voltage is detected in real time to trigger switching of the on/off state of the switching circuit. The voltage clamping is more accurate, and a device using the apparatus is less likely to be damaged by maloperation or inaccurate overvoltage clamping. An error in protection threshold of the above apparatus may be reach a level smaller than ten volts. Since such error in some overvoltage suppression components is as high as tens or hundreds of volts, the apparatus provided herein can protect a power grid better against transient overvoltage.

In an embodiment, an apparatus for overvoltage protection is provided. The apparatus for overvoltage protection comprises a voltage clamping circuit. The voltage clamping circuit comprises the voltage clamping sub-circuit connecting different phase lines at the AC side of the inverter circuit. The voltage clamping sub-circuit comprises the overvoltage suppressing circuit and the switching circuit. The switching circuit is turned on for providing a current path between the phase lines via the overvoltage suppressing circuit, in response to the voltage of a first phase line of the phase lines being outside the voltage range. The breakdown voltage of the overvoltage suppressing circuit is within the voltage range.

The apparatus for overvoltage protection is configured for suppressing overvoltage. As an example, the voltage clamping circuit in the apparatus is connected to the AC side of the inverter circuit, and the voltage clamping circuit clamps transient overvoltage occurring at the AC side of the inverter circuit. Hence, the electrical devices are less likely to be damaged by overvoltage, and the voltage at the AC side of the inverter circuit is maintained stable.

The inverter circuit is a circuit implementing conversion between direct current and alternating current. The inverter circuit may be a bidirectional inverter circuit which is configured for converting direct-current (DC) power at a DC side of the inverter circuit into AC power on the AC side, or vice versa.

The voltage clamping circuit comprises the voltage clamping sub-circuit. The voltage clamping sub-circuit connects different phase lines at the AC side of the inverter circuit. The voltage clamping circuit may comprise only one voltage clamping sub-circuit. As an example, the AC side of the inverter circuit comprises three phase lines corresponding to phase A, phase B, and phase C, respectively, and the voltage clamping sub-circuit is provided between phase A and phase B. That is, the voltage clamping sub-circuit is configured for voltage clamping when transient overvoltage occurs in phase A or phase B. Phase C may not have a voltage clamping sub-circuit connected to its phase line.

Alternatively, the voltage clamping circuit may comprise multiple voltage clamping sub-circuits, and different voltage clamping sub-circuits connect different pairs of phase lines. Each pair of phase lines may have a respective voltage clamping sub-circuit. As an example, the AC side of the inverter circuit comprises three phase lines corresponding to phase A, phase B, and phase C, respectively, and three voltage clamping sub-circuits are provided between each pair of phase lines. That is, a voltage clamping sub-circuit connects phase A and phase B, another voltage clamping sub-circuit connects phase B and phase C, and yet another voltage clamping sub-circuit connects phase A and phase C.

The voltage clamping sub-circuit comprises the overvoltage suppressing circuit and the switching circuit. A quantity of the switching circuit(s) in a single voltage clamping sub-circuit may be one or more, and a quantity of the overvoltage suppressing circuit(s) in a single voltage clamping sub-circuit may be one or more.

The switching circuit is configured for providing the current path between the two phase lines via the overvoltage suppressing circuit and cutting off such current path. In some embodiments, the current path is provided when the switch unit is turned on. At such time, a voltage difference between the two phase lines are applied across the overvoltage suppressing circuit. The current path is cut off when the switching circuit is turned off.

The switching circuit may comprise a semiconductor switch, such as a metal-oxide-semiconductor field-effect transistor (MOSFET) or an insulated-gate bipolar transistor (IGBT), or comprise an AC load switch, which is not limited herein.

The overvoltage suppressing circuit is a component configured for conducting when the voltage across the overvoltage suppressing circuit exceeding a preset voltage, such that excess power is discharged and the voltage is clamped within a safe range. For example, the overvoltage suppressing circuit is an overvoltage suppression component such as a varistor or a ceramic discharge tube. The overvoltage suppressing circuit may comprise multiple overvoltage suppression components connected in series and/or parallel, which is not limited herein.

In some embodiments, the overvoltage suppressing circuit may further comprise a heat dissipation device configured for dissipating heat from the overvoltage suppression component. Thereby, the lifetime of the overvoltage suppression component can be prolonged.

Herein the voltage range may be predetermined for evaluating whether overvoltage occurs at the AC side of the inverter circuit. Amplitude of a voltage of any phase line being outside the voltage range indicates that the overvoltage occurs at the AC side of the inverter circuit. The voltage range has a lower limit and an upper limit. The voltage at the AC side of the inverter circuit being in a positive half cycle and greater than the upper limit may indicate that the overvoltage occurs. The voltage at the AC side of the inverter circuit being in a negative half cycle and lower than the upper limit may also indicate that the overvoltage occurs.

Herein the voltage of the phase line may refer to a phase voltage, and the voltage range is configured corresponding to the phase voltage. The voltage across the phase line may alternatively refer to a line voltage, and the voltage range is configured corresponding to the line voltage.

In some embodiment, when amplitude of voltage(s) of any phase line(s) is outside the voltage range, the switching circuit in the voltage clamping sub-circuit connected to each of the phase line(s) is turned on to form a low impedance path, such that the corresponding overvoltage suppressing circuit can discharge excess power toward other phase line(s) to clamp and suppress the overvoltage.

For example, there are three phase lines for phase A, phase B and phase C at the AC side of the inverter circuit, and the voltage clamping sub-circuit is provided for any pair of phase lines. When the transient overvoltage occurs at phase A, the switching circuit in the voltage clamping sub-circuit between phase A and phase B is turned on, and the switching circuit in the voltage clamping sub-circuit between phase A and phase C is also turned on, so that the excess power in phase A is discharged toward other two phase lines to clamp the transient overvoltage.

When the transient overvoltage occurs at both phase A and phase B, the switching circuit in the voltage clamping sub-circuit between phase A and phase B is turned on, the switching circuit in the voltage clamping sub-circuit between phase A and phase C is turned on, and the switching circuit in the voltage clamping sub-circuit between phase B and phase C is turned on. Thereby, the excess power in each of phase A and phase B is discharged toward the other phase line(s) according to the status of the other phase line(s) to clamp the transient overvoltage. In addition, besides improving the accuracy of overvoltage suppression, the apparatus provided herein also reduces a requirement on voltage endurance of the switching circuit and the overvoltage suppressing circuit. Hence, design and selection are freer, and overall costs are controlled more easily. In a first aspect, the switching circuit and the overvoltage suppressing circuit are connected in series in the current path between the phase lines, so that the requirement on voltage endurance of both circuits are reduced, and the switching circuit and the overvoltage suppressing circuit can be selected with more flexibility, which helps reduce component costs and system complexity. In a second aspect, the voltage clamping circuit of the apparatus is highly decoupled from other modules, which facilitates independent maintenance and replacement and improves maintainability of the system. Such flexible design makes the apparatus applicable to single-phase, two-phase, and three-phase circuits and capable of providing efficient overvoltage protection in different operating environments. The high adaptability further enhances the safety of the power system and the reliability of the device, ensuring the stable operation of the system.

In some embodiments, the voltage clamping circuit comprises a common node and respective voltage clamping branches for multiple phase lines. Each voltage clamping branch connects its corresponding phase line and the common node. The voltage clamping sub-circuit that connects two phase lines comprises the respective voltage clamping branches of the two phase lines and the common node. The overvoltage suppressing circuit and the switching circuit of the voltage clamping sub-circuit are connected in series in one of the voltage clamping branches, and the voltage clamping branch is a part of the voltage clamping sub-circuit. Each phase line has its respective voltage clamping branch, and each phase line is directly connected to such voltage clamping branch. Each voltage clamping branch has a first node and a second node that serve as its two terminals. The voltage clamping branch may be connected to its corresponding phase line via the second node.

Herein the first nodes of the voltage clamping branches may be connected to form the common node, and each voltage clamping branch may comprise the overvoltage suppressing circuit and the switching circuit that are connected in series. Thus, the voltage clamping sub-circuit is formed by the respective voltage clamping branches of the phase lines, which it connects, and the common node. When the transient overvoltage occurs at any phase line which the voltage clamping sub-circuit connects, the switching circuit(s) in the voltage clamping sub-circuit are turned on to form a current path between the corresponding two phase lines via the voltage clamping branch of such phase line and the common node. Since the voltage clamping branch in the current paths comprises the overvoltage suppressing circuit, excessive power can be discharged to achieve overvoltage protection.

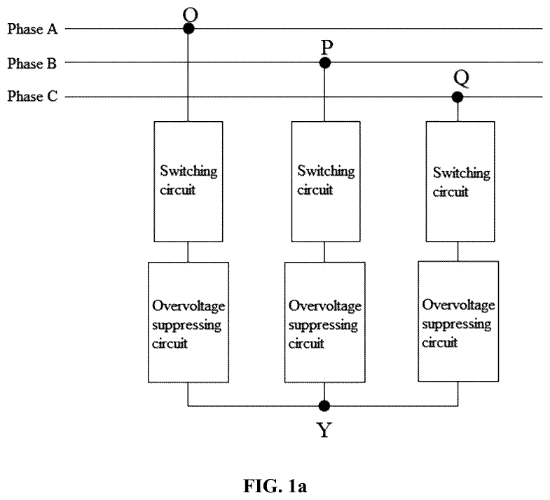

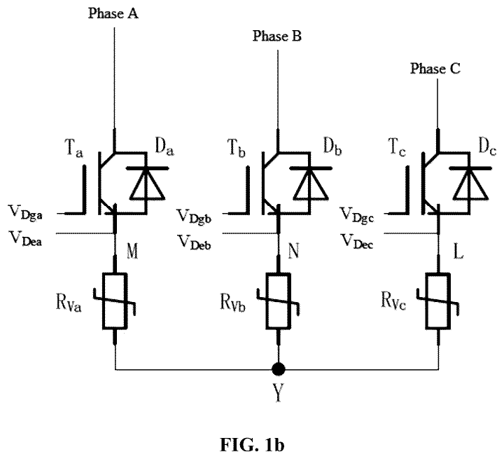

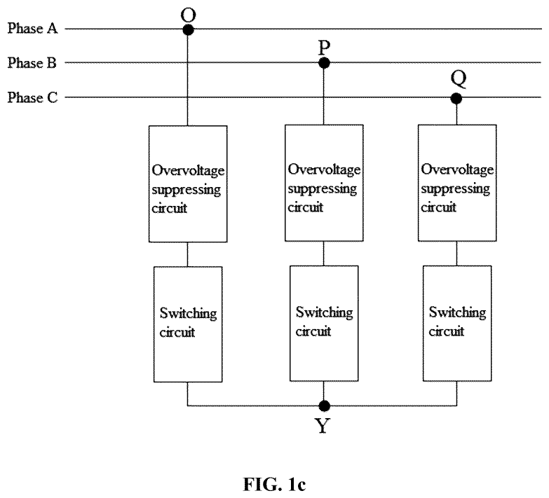

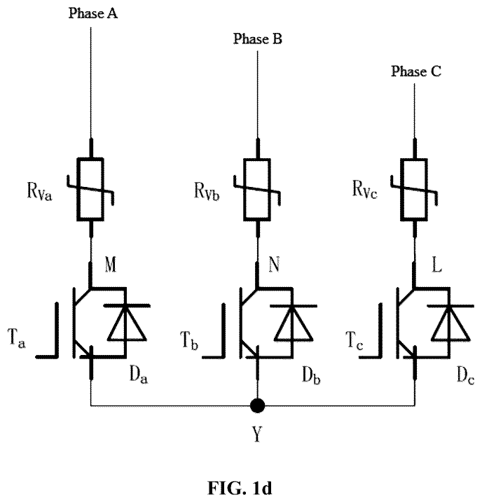

Reference is made to FIG. 1a, FIG. 1b, FIG. 1c, and FIG. 1d, which show some examples. It is assumed that there are three phase lines for phase A, phase B, and phase C, respectively at the AC side of the inverter circuit. The phase line of phase A and voltage clamping branch A are connected via node O, and voltage clamping branch A is located between node O and common node Y. The phase line of phase B and voltage clamping branch B are connected via node P, and voltage clamping branch B is located between node P and common node Y. The phase line of phase C and voltage clamping branch C are connected via node Q, and voltage clamping branch C is located between node Q and common node Y. Node O, node P and node Q are the second nodes of voltage clamping branch A, voltage clamping branch B, and voltage clamping branch C, respectively. Voltage clamping branch A, voltage clamping branch B, and voltage clamping branch C each comprises the overvoltage suppressing circuit and the switching circuit that are connected in series.

The first nodes of voltage clamping branch A, voltage clamping branch B, and voltage clamping branch C are connected together as common node Y, and a star connection is thus formed. As an example, reference is made to FIGS. 1b and 1d, where the overvoltage suppressing circuit is a varistor and the switching circuit is an IGBT. In FIGS. 1b and 1d, the IGBTs Tₐ, T_{b}, and T_{c} are connected in series with varistors Rᵥₐ, R_{vb} and R_{vc}, respectively, and the three sets of series connection are connected to common node Y to form the star connection.

The voltage clamping sub-circuit connecting the phase lines of phase A and phase B may comprise voltage clamping branch A, common node Y, and voltage clamping branch B. The voltage clamping sub-circuit connecting the phase lines of phase A and phase C may comprise voltage clamping branch A, common node Y, and voltage clamping branch C. The voltage clamping sub-circuit connecting the phase lines of phase B and phase C may comprise voltage clamping branch B, common node Y, and voltage clamping branch C. Hence, a voltage clamping branch may be multiplexed between the voltage clamping sub-circuits for different pairs of phase lines.

In some embodiments, the voltage clamping circuit comprises respective voltage clamping branches for different phase lines and multiple bridge branches. Each bridge branch connects different voltage clamping branches, and different bridge branches connect different pairs of voltage clamping branches. Each voltage clamping branch connects its corresponding phase line and the corresponding bridge branch(es). The voltage clamping sub-circuit for connecting two phase lines comprises the respective voltage clamping branches for the two phase lines and a bridge branch connecting these two voltage clamping branches. The overvoltage suppressing circuit of the voltage clamping sub-circuit is located in the bridge branch in the voltage clamping sub-circuit, and the switching circuit of the voltage clamping sub-circuit is located in one of the voltage clamping branches in the voltage clamping sub-circuit. In an embodiment, the bridge branch connects different voltage clamping branches. The first nodes of the multiple voltage clamping branches are connected via the multiple bridge branches. Each bridge branch comprises the overvoltage suppressing circuit, and each voltage clamping branch comprises the switching circuit. Thus, the voltage clamping sub-circuit may be formed by the respective voltage clamping branches for the phase lines, which it connects, and the bridge branch. When the transient overvoltage occurs at any phase line which a voltage clamping sub-circuit connects, the switching circuit(s) in the voltage clamping sub-circuit is turned on to form a current path between the corresponding phase lines via the respective voltage clamping branch for such phase line and the bridge branch. The bridge branch in the current path comprises the overvoltage suppressing circuit, so that excess power can be discharged to achieve overvoltage protection.

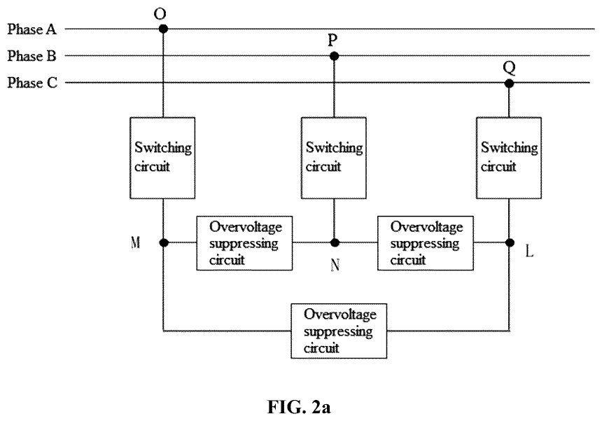

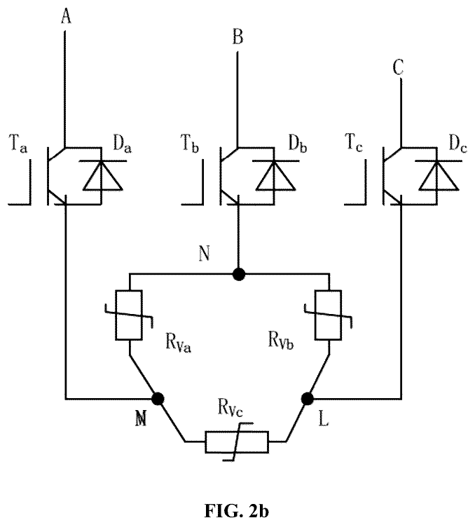

Reference to FIG. 2a and FIG. 2b, which show examples. It is assumed that there are three phase lines for phase A, phase B, and phase C, respectively, at the AC side of the inverter circuit. The phase line of phase A and voltage clamping branch A are connected via node O, and voltage clamping branch A is located between node O and node M. Node M may serve as the first node of voltage clamping branch A, and node O may serve as the second node of voltage clamping branch A. The phase line of phase B and voltage clamping branch B are connected via node P, and voltage clamping branch B is located between node P and node N. Node N may serve as the first node of voltage clamping branch B, and node P may serve as the second node of voltage clamping branch B. The phase line of phase C and voltage clamping branch C are connected via node Q, and voltage clamping branch C is located between node Q and node L. Node L may serve as the first node of voltage clamping branch C, and node Q may serve as the second node of voltage clamping branch C. Each of voltage clamping branch A, voltage clamping branch B, and voltage clamping branch C comprises the switching circuit.

The first nodes of voltage clamping branch A, voltage clamping branch B, and voltage clamping branch C are connected via the bridge branches. MN denotes the bridge branch connecting voltage clamping branch A and voltage clamping branch B, NL denotes the bridge branch connecting voltage clamping branch B and voltage clamping branch C, and ML denotes the bridge branch connecting voltage clamping branch A and voltage clamping branch C. Each bridge branch comprises the overvoltage suppressing circuit. That is, the voltage clamping circuit has a delta connection. Reference is further made to FIG. 2b. As an example, the overvoltage suppressing circuit is a varistor and the switching circuit is an IGBT. IGBTs Tₐ, T_{b}, and T_{c} are connected to node M, node N, and node L, respectively. Node M, node N, and node L may serve as the first node of voltage clamping branch A, the first node of voltage clamping branch B, and the first node of voltage clamping branch C, respectively.

The voltage clamping sub-circuit connecting the phase lines of phase A and phase B may comprise voltage clamping branch A, voltage clamping branch B, and bridge branch MN connected between voltage clamping branch A and voltage clamping branch B. The voltage clamping sub-circuit connecting the phase lines of phase A and phase C may comprise voltage clamping branch A, voltage clamping branch C, and bridge branch ML connected between voltage clamping branch A and voltage clamping branch C. The voltage clamping sub-circuit connecting the phase lines of phase B and phase C may comprise voltage clamping branch B, voltage clamping branch C, and bridge branch NL connected between voltage clamping branch B and voltage clamping branch C. Bridge branch MN, bridge branch ML, and bridge branch NL comprise varistor Rᵥₐ, varistor R_{vc}, and varistor R_{vb}, respectively.

In some embodiments, the switching circuit in the voltage clamping branch comprises an anti-parallel diode. A forward direction of the anti-parallel diode points to the phase line directly connected to such voltage clamping branch. When a voltage of any phase line at the AC side of the inverter circuit is greater than an upper limit of the voltage range, the switching circuit in the respective voltage clamping branch of such phase line is turned on. When a voltage of any phase line at the AC side of the inverter circuit is less than a lower limit of the voltage range, the switching circuit(s) in the voltage clamping branch(es), which are of other phase line(s) and belong to the voltage clamping sub-circuit(s) connected to such phase line, are turned on.

In some embodiments, the switching circuit comprises a semiconductor switch having a parasitic diode, and a forward direction of the parasitic diode points to the phase line directly connected to the voltage clamping branch comprising such switching circuit. The parasitic diode provides a unidirectional current channel when the switching circuit is turned off, and the unidirectional channel allows a current to flow toward the phase line directly connected to the voltage clamping branch. The parasitic diode may serve as the above anti-parallel diode.

Reference is further made to FIG. 1b, FIG. 1d, and FIG. 2b. As an example, the switching circuit comprises an IGBT, and the forward direction of the parasitic diode points to the phase line corresponding to the voltage clamping branch comprising such switching circuit. Thus, even when the switching circuit is turned off, voltage clamping branch provides a path for a current flowing into the corresponding phase line via the parasitic diode.

In some embodiments, the anti-parallel diode may be a separate diode of which a forward direction is opposite to a current flow direction of the turned-on switching circuit. Configuration of the anti-parallel diode is not limited herein.

When the voltage of a phase line is in a positive half cycle and presents overvoltage, voltage clamping requires forming a current path from such phase line via the overvoltage suppressing circuit to other phase line(s). When a voltage of a phase line is in a negative half cycle and presents overvoltage, voltage clamping requires forming a current path from other phase line(s) via the overvoltage suppressing circuit(s) to such phase line. Hence, the unidirectional conduction characteristic of the anti-parallel diode may be utilized. When amplitude of the voltage of any phase line is outside the voltage range, only a part of the switching circuits in the voltage clamping sub-circuit(s) directly connected to the phase line needs to be controlled to achieve the voltage clamping, and hence a control logic is simplified. The anti-parallel diode also provides a fast-response current path during transition of circuit states, and hence a risk of damage due to sudden voltage changes is reduced.

In an embodiment, when the voltage of any phase line at the AC side of the inverter circuit is greater than the upper limit of the voltage range, the switching circuit in the voltage clamping branch directly connected to such phase line is turned on, while the switching circuit(s) in the voltage clamping branch(es) directly connected to other phase line(s) may be kept off.

As an example, there are three phase lines of phase A, phase B, and phase C at the AC side of the inverter circuit and the anti-parallel diodes are the parasitic diode. When the voltage of the phase line of phase A is greater than the upper limit of the voltage range, the switching circuit in the voltage clamping branch directly connected to the phase line of phase A is turned on. In such case, a current can flow from the phase line of phase A, then via the overvoltage suppressing circuit, and then via the parasitic diode of the switching circuit for phase B to the phase line of phase B as well as via the parasitic diode of the switching circuit for phase C to the phase line of phase C. Thereby, the overvoltage is suppressed.

Reference is further made to FIG. 1b, in which the voltage clamping circuit has the star connection. When transient overvoltage occurs in a positive half cycle at phase A, the IGBT T is turned on. The current can flow from phase A and passes IGBT Tₐ, node M, and varistor R_{Va} to common node Y. Then, the current is shunted to a path passing varistor R_{Vb}, node N, and parasitic diode D_{b} of IGBT T_{b} and reaches phase B, and the current is also shunted to a path passing varistor R_{Vc}, node L, and parasitic diode D_{c} of IGBT T_{c} and reaches phase C.

When transient overvoltage occurs in a positive half cycle at phase B, the IGBT T_{b} is turned on. The current can flow from phase B and passes IGBT T_{b}, node N, and varistor R_{Vb} to common node Y. Then, the current is shunted to a path passing varistor R_{Va}, node M, and parasitic diode Dₐ of IGBT Tₐ and reaches phase A, and the current is also shunted to a path passing varistor R_{Vc}, node L, and parasitic diode D_{c} of IGBT T_{c} and reaches phase C.

When transient overvoltage occurs in a positive half cycle at phase C, the IGBT T_{c} is turned on. The current can flow from phase C and passes IGBT T_{c}, node L, and varistor R_{Vc} to common node Y. Then, the current is shunted to a path passing varistor R_{Va}, node M, and parasitic diode Dₐ of IGBT Tₐ and reaches phase A, and the current is also shunted to a path passing varistor R_{Vb}, node N, and parasitic diode D_{b} of IGBT T_{b} and reaches phase B.

Reference is further made to FIG. 1d which shows another example. When transient overvoltage occurs in a positive half cycle at phase A, the IGBT Tₐ is turned on. The current can flow from phase A and passes varistor R_{Va}, node M, and IGBT Tₐ to common node Y. Then, the current is shunted to a path passing parasitic diode D_{b} of IGBT T_{b}, node N, and varistor R_{Vb} and reaches phase B, and the current is also shunted to a path passing parasitic diode D_{c} of IGBT T_{c}, node L, and varistor R_{Vc} and reaches phase C.

When transient overvoltage occurs in a positive half cycle at phase B, the IGBT T_{b} is turned on. The current can flow from phase B and passes varistor R_{Vb}, node N, and IGBT T_{b} to common node Y. Then, the current is shunted to a path passing parasitic diode Dₐ of IGBT Tₐ, node M, and varistor R_{Va} and reaches phase A, and the current is also shunted to a path passing parasitic diode D_{c} of IGBT T_{c}, node L, and varistor R_{Vc} and reaches phase C.

When transient overvoltage occurs in a positive half cycle at phase C, the IGBT T_{c} is turned on. The current can flow from phase C and passes varistor R_{Vc}, node L, and IGBT T_{c} to common node Y. Then, the current is shunted to a path passing parasitic diode Dₐ of IGBT Tₐ, node M, and varistor R_{Va} and reaches phase A, and the current is also shunted to a path passing parasitic diode D_{b} of IGBT T_{b}, node N, and varistor R_{Vb} and reaches phase B.

Reference is further made to FIG. 2b, in which the voltage clamping circuit has the delta connection. When transient overvoltage occurs in a positive half cycle at phase A, IGBT Tₐ is turned on. The current can flow from phase A, and pass the IGBT Tₐ and node M. Then, the current is shunted to varistor R_{Va}, node N, and parasitic diode D_{b} of IGBT T_{b} and reaches phase B, and the current is also shunted to varistor R_{Vc}, node L, and parasitic diode D_{c} of IGBT T_{c} and reaches phase C.

When transient overvoltage occurs in a positive half cycle at phase B, IGBT T_{b} is turned on. The current can flow from phase B, and pass the IGBT T_{b} and node N. Then, the current is shunted to varistor R_{Va}, node M, and parasitic diode Dₐ of IGBT Tₐ and reaches phase A, and the current is also shunted to varistor R_{Vb}, node L, and parasitic diode D_{c} of IGBT T_{c} and reaches phase C.

When transient overvoltage occurs in a positive half cycle at phase C, IGBT T_{c} is turned on. The current can flow from phase C, and pass the IGBT T_{c} and node L. Then, the current is shunted to varistor R_{Vc}, node M, and parasitic diode Dₐ of IGBT Tₐ and reaches phase A, and the current is also shunted to varistor R_{Vb}, node N, and parasitic diode D_{b} of IGBT T_{b} and reaches phase B.

When the voltage of any phase line at the AC side of the inverter circuit is less than the lower limit of the voltage range, the switching circuit in the voltage clamping branch directly connected to such phase line may be kept off, while the switching circuit(s) in the voltage clamping branch(es) directly connected to other phase line(s) are turned on.

The voltage clamping circuit adopting the above delta connection is taken as an example. It is assumed that there are three phase lines of phase A, phase B, and phase C at the AC side of the inverter circuit, and the anti-parallel diode is the parasitic diode. When the voltage of the phase line of phase A decreases below the lower limit of the voltage range, the switching circuit in the voltage clamping branch directly connected to phase B is turned on, and/or the switching circuit in the voltage clamping branch directly connected to phase C is turned on. Thereby, power of phase B and/or phase C are introduced into phase A via the corresponding voltage clamping sub-circuit(s) to balance the voltage of the phase line of phase A.

Reference is further made to FIG. 1b which shows an example. When the transient overvoltage occurs in a negative half cycle at phase A, the IGBT T_{b} and/or the IGBT T_{c} are turned on. A current can flow from phase B and passes IGBT T_{b}, node N, varistor R_{Vb}, and common node Y, and/or a current can flow from phase C and passes IGBT T_{c}, node L, varistor R_{Vc}, and common node Y. The above currents may converge at common node Y. Afterwards, the current(s) flow into phase A via varistor R_{Va}, node M, and parasitic diode Dₐ of IGBT Tₐ.

When the transient overvoltage occurs in a negative half cycle at phase B, the IGBT Tₐ and/or the IGBT T_{c} are turned on. A current can flow from phase A and passes IGBT Tₐ, node M, varistor R_{Va}, and common node Y, and/or a current can flow from phase C and passes IGBT T_{c}, node L, varistor R_{Vc}, and common node Y. The above currents may converge at common node Y. Afterwards, the current(s) flow into phase B via varistor R_{Vb}, node N, and parasitic diode D_{b} of IGBT T_{b}.

When the transient overvoltage occurs in a negative half cycle at phase C, the IGBT Tₐ and/or the IGBT T_{b} are turned on. A current can flow from phase A and passes IGBT Tₐ, node M, varistor R_{Va}, and common node Y, and/or a current can flow from phase B and passes IGBT T_{b}, node N, varistor R_{Vb}, and common node Y. The above currents may converge at common node Y. Afterwards, the current(s) flow into phase C via varistor R_{Vc}, node L, and parasitic diode D_{c} of IGBT T_{c}.

Reference is further made to FIG. 1d which shows another example. When the transient overvoltage occurs in a negative half cycle at phase A, the IGBT T_{b} and/or the IGBT T_{c} are turned on. A current can flow from phase B and passes varistor R_{Vb}, node N, IGBT T_{b}, and common node Y, and/or a current can flow from phase C and passes varistor R_{Vc}, node L, IGBT T_{c}, and common node Y. The above currents may converge at common node Y. Afterwards, the current(s) flow into phase A via parasitic diode Dₐ of IGBT Tₐ, node M, and varistor R_{Va}.

When the transient overvoltage occurs in a negative half cycle at phase B, the IGBT Tₐ and/or the IGBT T_{c} are turned on. A current can flow from phase A and passes varistor R_{Va}, node M, IGBT Tₐ, and common node Y, and/or a current can flow from phase C and passes varistor R_{Vc}, node L, IGBT T_{c}, and common node Y. The above currents may converge at common node Y. Afterwards, the current(s) flow into phase B via parasitic diode D_{b} of IGBT T_{b}, node N, and varistor R_{Vb}.

When the transient overvoltage occurs in a negative half cycle at phase C, the IGBT Tₐ and/or the IGBT T_{b} are turned on. A current can flow from phase A and passes varistor R_{Va}, node M, IGBT Tₐ, and common node Y, and/or a current can flow from phase B and passes varistor R_{Vb}, node N, IGBT T_{b}, and common node Y. The above currents may converge at common node Y. Afterwards, the current(s) flow into phase C via parasitic diode D_{c} of IGBT T_{c}, node L, and varistor R_{Vc}.

Reference is further made to FIG. 2b which shows another example in which the voltage clamping circuit adopts the above delta connection. When the transient overvoltage occurs in a negative half cycle at phase A, the IGBT T_{b} and/or the IGBT T_{c} are turned on. A current can flow from phase B and passes IGBT T_{b}, node N, varistor R_{Va}, and node M, and/or a current can flow from phase C and passes IGBT T_{c}, node L, varistor R_{Vc}, and node M. The above currents may converge at node M. Afterwards, the current(s) flow into phase A via parasitic diode Dₐ of IGBT Tₐ.

When the transient overvoltage occurs in a negative half cycle at phase B, the IGBT Tₐ and/or the IGBT T_{c} are turned on. A current can flow from phase A and passes IGBT Tₐ, node M, varistor R_{Va}, and node N, and/or a current can flow from phase C and passes IGBT T_{c}, node L, varistor R_{Vb}, and node N. The above currents may converge at node N. Afterwards, the current(s) flow into phase B via parasitic diode D_{b} of IGBT T_{b}.

When the transient overvoltage occurs in a negative half cycle at phase C, the IGBT Tₐ and/or the IGBT T_{b} are turned on. A current can flow from phase A and passes IGBT Tₐ, node M, varistor R_{Vc}, and node L, and/or a current can flow from phase B and passes IGBT T_{b}, node N, varistor R_{Vb}, and node L. The above currents may converge at node L. Afterwards, the current(s) flow into phase C via parasitic diode D_{c} of IGBT T_{c}.

In some embodiments, the apparatus further comprises a voltage detecting circuit. The voltage detecting circuit is configured for: detecting the voltage of the phase line, and outputting an abnormal-voltage signal for the phase line when the voltage of the phase line is outside the voltage range. The abnormal-voltage signal is configured for turning off the switching circuit in the voltage clamping sub-circuit connected to the phase line.

The voltage detecting circuit refers to circuitry for detecting the voltage of the phase line at the AC side of the inverter circuit. When amplitude of the voltage of the phase line is outside the voltage range, the voltage detecting circuit outputs the abnormal-voltage signal. The voltage detecting circuit may monitor voltage fluctuations on the phase line in real time and determines whether the voltage is greater than the upper limit of the voltage range or less than the lower limit of the voltage range. When the anormal voltage (e.g., overvoltage), occurs, the voltage detecting circuit generates a control signal, e.g., the abnormal-voltage signal, for controlling the switching circuit in the voltage clamping sub-circuit.

The abnormal-voltage signal indicates that the voltage of the phase line is abnormal. When the voltage of the phase line is greater than the upper limit of the voltage range or lower than the lower limit of the voltage range, the voltage detecting circuit generates the abnormal-voltage signal.

In some embodiments, the abnormal-voltage signal may be a low-level signal or a high-level signal. The voltage detecting circuit may output one level (for example, a high level) when the voltage is within the voltage range, and output another level (for example, a low level) when it detects that the voltage is outside the voltage range. The change in the level forms a pulse signal which may be used for indicating whether the voltage is abnormal within a period of time.

The voltage detecting circuit may use another logic. For example, the abnormal-voltage signal may use a high level to indicate the abnormal voltage while use the low level to indicate the normal voltage. The logic is not limited herein.

The voltage detecting circuit may output the abnormal-voltage signals that are in one-to-one correspondence to all phase lines. For example, the voltage detecting circuit may have multiple output terminals corresponding to the phase lines, respectively, and output abnormal-voltage signals corresponding to the phase lines, respectively. Alternatively, the voltage detecting circuit may output the abnormal-voltage signal that uses different levels or different voltage amplitude to indicate which phase line is subject to transient overvoltage. The present disclosure is not limited to the above manners.

The abnormal-voltage signal may directly serve as a driving signal for the switching circuit in the voltage clamping sub-circuit. Alternatively, the abnormal-voltage signal may be processed by analog and/or digital circuitry and converted into a control signal adapted for driving the switching circuit. In some embodiments, the abnormal-voltage signal is processed by a logic control unit, such as a complex programmable logic device (CPLD) or a field-programmable gate array (FPGA), and thus is converted into a broadened and/or delayed pulsed driving signal. Hence, the driving signal may meet a demand for transient response of the switching circuit operating under high frequency.

In some embodiments, the voltage detecting circuit comprises a voltage sampling sub-circuit and a voltage comparing sub-circuit. The voltage sampling sub-circuit is configured for sampling the voltage of the phase line with reference to a virtual neutral point and outputting the sampled voltage to the voltage comparing sub-circuit. The voltage comparing sub-circuit is configured for comparing the sampled voltage with an upper limit and a lower limit of the voltage range, and outputting the abnormal-voltage signal when the sampled voltage is greater than the upper limit or smaller than the lower limit.

The voltage sampling circuit and the voltage comparing sub-circuit each may be implemented as an analog circuit or a digital circuit.

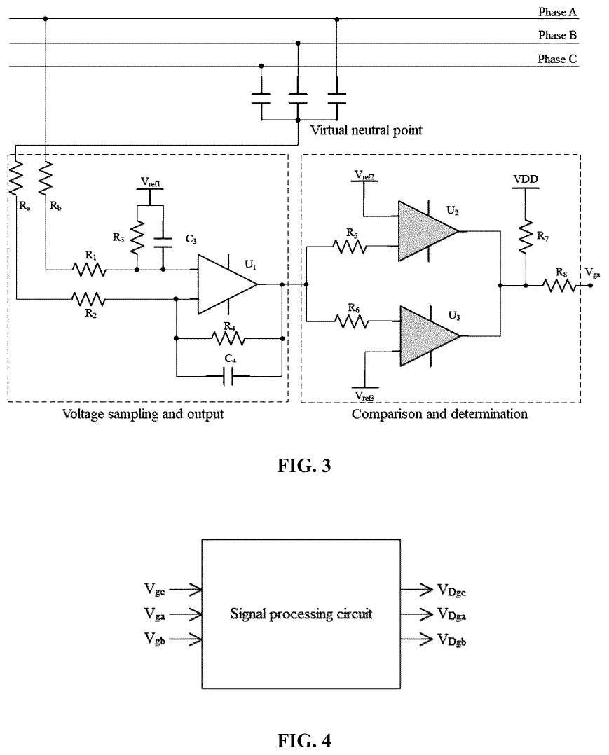

In some embodiments, the voltage sampling circuit comprises an operational amplifier. Reference is made to FIG. 3, which shows an example of sampling on the voltage of the phase line of phase A.

In the voltage sampling circuit, a non-inverting input terminal of the operational amplifier U₁ is connected to phase line A via resistor R₁ and resistor R_{b} to sample the voltage at phase A. The non-inverting input terminal is connected to bias voltage V_{ref1} via resistor R₃ and capacitor C₃ that are connected in parallel. Bias voltage V_{ref1} is configured for providing a reference for the sampled voltage, so that the acquired AC voltage is converted into a DC signal fluctuating around bias voltage V_{ref1}. That is, the reference for the sampled voltage is offset from 0V to the bias voltage, so that waveforms of the positive and negative half-cycle of the AC voltage at phase A can be processed according to the reference defined by bias voltage V_{ref1}, which facilitates subsequent comparison and determination.

An inverting input terminal of the operational amplifier U₁ is connected to virtual point N, i.e., a virtual neutral point, via resistor R₂ and resistor Rₐ. Virtual point N is a common connection point at which currents from three phase lines converge. The inverting input terminal divides the voltage across phase A according to resistor Rₐ and resistor R_{b}. Resistance of the resistor Rₐ and the resistor R_{b} may be equal. In some embodiments, one or both of resistor Rₐ and resistor R_{b} comprises multiple resistors connected in series. The above structure improves accuracy of the voltage division and ensures a linear response of the circuit in different voltage ranges. The inverting input terminal is also connected to an output terminal of the operational amplifier U₁ via resistor R₄ and capacitor C₄ that are connected in parallel. Resistor R₄ and capacitor C₄ determine a cutoff frequency of the sampled signal, and hence high-frequency noise can be effectively removed, thereby improving signal quality.

In some embodiments, resistor R₁ and resistor R₂ may be disposed close to the operational amplifier U₁. Hence, robustness of the divided sampling signal against interferences due to when long PCB traces can be improved.

The output terminal of the voltage sampling circuit is connected with an input terminal of the voltage comparing sub-circuit, and an output terminal of the voltage comparing sub-circuit serves as the output terminal V_{ga} of the voltage detecting circuit. In some embodiments, the voltage comparing sub-circuit comprises two comparators U₂ and U₃. A first input terminal of comparator U₂ is connected to reference voltage V_{ref2}, and a second input terminal of the comparator U₂ is connected to the output terminal of the voltage sampling circuit via resistor R₅. A first input terminal of the comparator U₃ is connected to the output terminal of the voltage sampling circuit through the resistor R₆, and a second input terminal of comparator U₃ is connected to reference voltage V_{ref3}. Reference voltage V_{ref2} and reference voltage V_{ref3} correspond to the upper limit and the lower limit, respectively, of the voltage range.

The output terminals of comparator U₂ and comparator U₃ are connected to each other, and they are connected to high level VDD via pull-up resistor R₇. The output terminals of comparator U₂ and comparator U₃ are also connected to the output terminal V_{ga} of the voltage detecting circuit via resistor R₈.

The comparators U₂ and U₃ may both be configured as follows. A high level is output when a voltage at the first input terminal is greater than a voltage at the second input terminal, and a low level is output when the voltage at the first input terminal is lower than the voltage at the second input terminal. When the voltage of the phase line is within the voltage range, the sampled voltage at the output terminal of the voltage sampling circuit is larger than the reference voltage V_{ref3} and smaller than the reference voltage V_{ref2}. Hence, both comparator U₂ and comparator U₃ output high levels. Accordingly, the output terminal V_{ga} of the voltage detecting circuit outputs high level VDD.

When the voltage of the phase line is in a positive half cycle and higher than the reference voltage V_{ref2}, or is in a negative half cycle and lower than the reference voltage V_{ref3}, comparator U₂ or comparator U₃ outputs a low level. In such case, the output terminal V_{ga} of the voltage detecting circuit is flipped from the high level to a low level, and thus the abnormal-voltage signal is outputted to indicate that the voltage of the phase line is outside the voltage range.

In some embodiments, each phase line is provided with its respective voltage sampling sub-circuit and its respective voltage comparing sub-circuit, such that a state of the voltage of such phase line can be detected. The circuitry for phase B and phase C is similar to that of phase A and hence would not be illustrated in detail herein.

In some embodiments, the apparatus further comprises a signal processing circuit. The signal processing circuit has an input terminal and an output terminal that corresponds to the switching circuit in the voltage clamping sub-circuit. The signal processing circuit is configured for delaying and/or broadening the abnormal-voltage signal to obtain a switch closing signal in response to the input terminal receiving the abnormal-voltage signal. The switch closing signal is configured for turning on the switching circuit(s) in the voltage clamping sub-circuit(s) connected to the phase line.

The signal processing circuit is configured for processing the abnormal-voltage signal and controlling the switching circuit(s) in the voltage clamping sub-circuit(s) through the switch closing signal.

The signal processing circuit has the input terminal and the output terminal. The input terminal is configured for receiving the abnormal-voltage signal. The abnormal-voltage signal may be from the voltage detecting circuit another device in the power system.

For example, in the power system comprises an inverter. When the inverter detects that amplitude of the voltage of any phase line at the AC side of the inverter circuit is outside the voltage range, the inverter may transmit the abnormal-voltage signal to a communication module of the signal processing circuit. After decoded by the communication module, the signal is transmitted to the input terminal.

The output terminal is configured for outputting the switch closing signal. In some embodiments, the output terminal is connected to a driving circuit. The switch closing signal is first sent to the driving circuit for processing, and the processed switch closing signal is then sent to a control terminal of the switching circuit. In some alternative embodiments, the output terminal is directly connected to the control terminal of the switching circuit in the voltage clamping sub-circuit. The switch closing signal is directly transmitted to the switching circuit to turn on or turn off the switching circuit. The present disclosure is not limited to the above cases.

After receiving the abnormal-voltage signal, the signal processing circuit may delay or broaden the signal to obtain the switch closing signal. The signal processing circuit may both delay and broaden the abnormal-voltage signal.

The duration of the abnormal-voltage signal reflects the duration of the transient overvoltage at the phase line. When the abnormal-voltage signal is delayed, a moment at which the switching circuit is turned off is later than a moment at which the transient overvoltage disappears. Such delay processing ensures that the operation of the switching circuit is later than completion of a suppressing operation of the overvoltage suppressing circuit. Hence, high-frequency oscillations caused by turning off the switching circuit too early are less likely to occur, and damages on the switching circuit due to the high-frequency oscillations can be avoided.

For example, the overvoltage suppressing circuit comprises the varistor. When the abnormal-voltage signal is delayed, it is ensured that the moment at which the switch closing signal disappears is later than the moment at which the varistor returns to its high impedance state. Thus, the risk of damaging the switching circuit is reduced.

Broadening the abnormal-voltage signal can reduce the risk of maloperation and frequent jitter of the switching circuit, which are caused by narrow pulses. The unstable actions may trigger high-frequency oscillations in the circuit and further amplify voltage spikes, which damages the apparatus. Through the broadening, the duration of the abnormal-voltage signal is increased, which ensures that the on-state of the switching circuit is long enough to maintain a stable operation and lessens accumulation of spike stress. The broadening also prolongs conducting duration of the switching circuit, which reduces the electrical fatigue caused by frequent switching operations and prolongs the service life of the switching circuit.

Coordination of the delaying and the broadening may achieve more accurate control. In such case, the damage caused by voltage peaks and current impulses to the switching circuit and the overvoltage suppressing circuit are reduced, the anti-interference capability of the apparatus for overvoltage protection is improved, and stability of the system is ensured in complex operating environments. In addition, the coordination also achieves an optimal balance between response speed and stability and further improves reliability and adaptability of the whole system.

In some embodiments, the signal processing circuit is implemented as an analog circuit and/or a digital circuit. The signal processing circuit may comprise a logic control unit such as a single chip microcomputer, a CPLD, or an FPGA, such that conducting duration of the switching circuit may be flexibly adjusted according to a half cycle of the phase line subject to overvoltage.

The signal processing circuit may have multiple input terminals and multiple output terminals. The multiple input terminals are configured for receiving the abnormal-voltage signals generated by the phase lines, respectively, when the transient overvoltage occurs. The multiple output terminals are connected to different switching circuits, respectively, to control the on-off state of the switching circuits through the switch closing signals.

Reference is made to FIG. 4, which shows an example. There are three phase lines of phase A, phase B, and phase C, respectively, at the AC side of the inverter circuit, and there are three input terminals and three output terminals in the signal processing circuit. The three input terminals are input terminal A, input terminal B and input terminal C. Input terminal A, input terminal B, and input terminal C are configured for receiving abnormal-voltage signal V_{ga} of phase A, abnormal-voltage signal V_{gb} of phase B, and abnormal-voltage signal V_{gc} of phase C, respectively.

The output terminals of the signal processing circuit comprise output terminal A, output terminal B, and output terminal C. Output terminal A is connected to the control terminal of the switching circuit in the voltage clamping branch directly connected to the phase line of phase A, output terminal B is connected to the control terminal of the switching circuit in the voltage clamping branch directly connected to the phase line of phase B, and output terminal C is connected to the control terminal of the switching circuit in the voltage clamping branch directly connected to the phase line of phase C.

The switch closing signal outputted by output terminal A is switch closing signal V_{Dga}, which is for controlling the switching circuit in the voltage clamping branch directly connected to the phase line of phase A. Similarly, the switch closing signal outputted by output terminal B is switch closing signal V_{Dgb}, which is for controlling the switching circuit in the voltage clamping branch directly connected to the phase line of phase B, and the switch closing signal outputted by output terminal C is switch closing signal V_{Dgc}, which is for controlling the switching circuit in the voltage clamping branch directly connected to the phase line of phase C.

On such basis, when the switching circuit comprises the anti-parallel diode and the forward direction of the anti-parallel diode points to the phase line directly connected to the corresponding voltage clamping branch, the signal processing circuit may control one or more output terminals according to the state of the voltage of the phase line and thereby control the on-off state of the corresponding switching circuit.

Reference is made to FIG. 1b, FIG. 1d and FIG. 2b. When the transient overvoltage occurs in a positive half cycle at a phase line, the signal processing circuit turns on the switching circuit in the voltage clamping branch directly connected to such phase line. When the transient overvoltage occurs in a negative half cycle at a phase line, the signal processing circuit turns on the switching circuit(s) in the voltage clamping branch(es) directly connected to other phase line(s). Thereby, power is reasonably distributed.

As an example, when a transient overvoltage occurs in a positive half cycle at the phase line of phase A, input terminal A receives abnormal-voltage signal V_{ga}. The signal processing circuit processes abnormal-voltage signal V_{ga} to output switch closing signal V_{Dga}, and turns on the switching circuit in the voltage clamping branch directly connected to the phase line of phase A through output terminal A.

Similarly, when a transient overvoltage occurs in a positive half cycle at the phase line of phase B, input terminal B receives abnormal-voltage signal V_{gb}. The signal processing circuit processes abnormal-voltage signal V_{gb} to output switch closing signal V_{Dgb}, and turns on the switching circuit in the voltage clamping branch directly connected to the phase line of phase B through output terminal B.

Similarly, when a transient overvoltage occurs in a positive half cycle at the phase line of phase C, input terminal C receives abnormal-voltage signal V_{gc}. The signal processing circuit processes abnormal-voltage signal V_{gc} to output switch closing signal V_{Dgc}, and turns on the switching circuit in the voltage clamping branch directly connected to the phase line of phase C through output terminal C.

When the voltage is in a negative half cycle, the signal processing circuit may adopt a different control strategy. As an example, when the transient overvoltage occurs in a negative half cycle at the phase line of phase A, input terminal A receives abnormal-voltage signal V_{ga}. The signal processing circuit generates switch closing signal V_{Dgb} and switch closing signal V_{Dgc}, turns on the switching circuit in the voltage clamping branch directly connected to the phase line of phase B through output terminal B, and turns on the switching circuit in the voltage clamping branch directly connected to phase C through output terminal C.

Similarly, when the transient overvoltage occurs in a negative half cycle at the phase line of phase B, input terminal B receives abnormal-voltage signal V_{gb}. The signal processing circuit generates switch closing signal V_{Dga} and switch closing signal V_{Dgc}, turns on the switching circuit in the voltage clamping branch directly connected to the phase line of phase A through output terminal A, and turns on the switching circuit in the voltage clamping branch directly connected to phase C through output terminal C.

Similarly, when the transient overvoltage occurs in a negative half cycle at the phase line of phase C, input terminal C receives abnormal-voltage signal V_{gc}. The signal processing circuit generates switch closing signal V_{Dga} and switch closing signal V_{Dgb}, turns on the switching circuit in the voltage clamping branch directly connected to the phase line of phase A through output terminal A, and turns on the switching circuit in the voltage clamping branch directly connected to phase B through output terminal B.

In some embodiments, the apparatus further comprises an isolating-driving circuit corresponding to the switching circuit. The isolating-driving circuit has an input terminal and an output terminal that are electrically isolated from each other. The isolating-driving circuit is configured for applying a turn-on voltage to the corresponding switching circuit through the output terminal to turn on the switching circuit when receiving the switch closing signal.

The apparatus for overvoltage protection comprises the isolating-driving circuit. The isolating-driving circuit is connected to the switching circuit and configured for controlling the switching circuit. The isolating-driving circuit has the input terminal and the output terminal that are electrically isolated through an isolation component.

The apparatus for overvoltage protection comprises the isolating-driving circuit electrically connected to the switching circuit, and the isolating-driving circuit is configured for controlling the switching circuit. The input terminal of the isolating-driving circuit is configured for receiving the switch closing signal. When amplitude of the voltage of the phase line is outside the voltage range, the input terminal receives the corresponding switch closing signal, and the output terminal generates the turn-on voltage according to the switch closing signal and applies the turn-on voltage to the corresponding switching circuit. Thereby, the switching circuit is turned on.

The driving capability of the switching circuit is enhanced by using the isolating-driving circuit. The electrical isolation between the input terminal and the output terminal of the isolating-driving circuit ensures stable transmission of the control signal and reduces the risk of damage caused by voltage fluctuations or overvoltage at the phase line. Hence, the apparatus for overvoltage protection is more reliable.

In some embodiments, the electrical isolation between the input terminal and the output terminal is implemented through an opto-isolator. Reference is made to FIG. 5. The isolating-driving circuit for controlling the switching circuit in the voltage clamping branch directly connected to the phase line of phase A is taken as an example. A primary side of opto-isolator U₄ in the isolating-driving circuit comprises a light-emitting diode. An anode of the light-emitting diode is connected to high level VDD via resistor R9. A cathode of the light-emitting diode is connected to resistor R10 and configured for receiving the switch closing signal. As an example, the cathode of the light-emitting diode is connected to the output terminal of the signal processing circuit via resistor R10 to receive the switch closing signal outputted from such output terminal. As another example, the cathode of the light-emitting diode is directly connected to a terminal, which outputs the abnormal-voltage signal, via resistor R10, and the abnormal-voltage signal serves directly as the switch closing signal. The light-emitting diode is connected in parallel with resistor R11, and resistors R9 and R10 are current-limiting resistors for protecting the light-emitting diode at the primary side of opto-isolator U₄.

A secondary side of the opto-isolator U₄ is connected to positive voltage power supply Vₛₛ and negative voltage power supply Vₑₑ. Positive voltage power supply Vₛₛ provides a forward voltage for turning on the switching circuit, and negative voltage power supply Vₑₑ provides a reverse voltage for turning off the switching circuit. Capacitors C11 and C12 are connected in series between positive voltage power supply Vₛₛ and negative voltage power supply Vₑₑ and define virtual neutral point V_{Dea} that serves as a reference ground for the positive and negative voltage power supplies.

When the switch closing signal V_{Dga} is at the high level, potentials at two terminals of the light-emitting diode at the primary side of the opto-isolator U₄ are equal, so that no current flows through the light-emitting diode and no light is emitted from the light-emitting diode. Hence, output voltage V_{Dga} at the secondary side of the opto-isolator U₄ is the voltage of negative voltage power supply Vₑₑ.

When the switch closing signal V_{Dga} is at the low level, the potential at the anode of the light-emitting diode is greater than the potential at the cathode of the light-emitting diode, a current flows through the light-emitting diode, and the light-emitting diode emits light. Hence, output voltage V_{Dga} at the secondary side of the opto-isolator U₄ is the voltage of the positive voltage power supply Vₛₛ. The turn-on voltage is voltage between the output voltage V_{Dga} of the secondary side and the virtual neutral point V_{Dea}.

Reference is made to FIG. 1b for example. When the switching circuit is an IGBT, the turn-on voltage is applied between its gate and emitter. When the turn-on voltage is a voltage between positive voltage power supply Vₛₛ and virtual neutral point V_{Dea}, the IGBT is turned on under the forward voltage. When the turn-on voltage is voltage between negative voltage power supply Vₑₑ and virtual neutral point V_{Dea}, the IGBT is turned off under the reverse voltage. Thereby, the isolating-driving circuit is capable of controlling the switching circuit accurately.

In some embodiments, the electrical isolation between the input terminal of and the output terminal of the drive circuit may be implemented using another type of isolation, such as magnetic isolation or capacitive isolation. The present disclosure is not limited to the above isolation types.

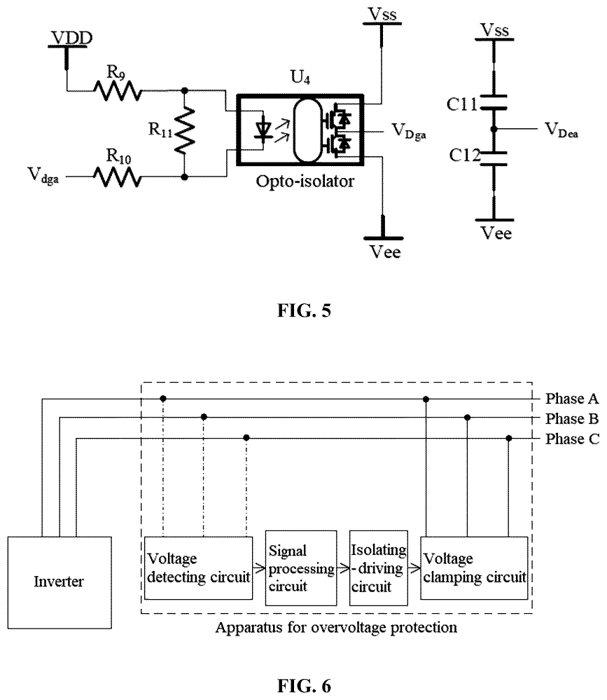

Referring is made to FIG. 6. In an embodiment, the apparatus for overvoltage protection comprises the voltage detecting circuit, the signal processing circuit, the isolating-driving circuit, and the voltage clamping circuit. The voltage detecting circuit is configured for detecting the voltage of the phase line at the AC side of the inverter circuit, and outputting the abnormal-voltage signal when the voltage of the phase line is outside the voltage range. The signal processing circuit is configured for delaying and/or broadening the abnormal-voltage signal to obtain the switch closing signal. The isolating-driving circuit is configured for applying the turn-on voltage to the corresponding switching circuit to turn on the switching circuit according to the switch closing signal.

The voltage detecting circuit is configured for detecting the voltage of the phase line at the AC side of the inverter circuit in real time, and outputting the abnormal-voltage signal when detecting that the voltage of the phase line is outside the voltage range in the positive or negative half cycle. The duration of the abnormal-voltage signal depends on duration of a period in which the voltage of phase line is outside the voltage range.

The abnormal-voltage signal is transmitted to the signal processing circuit. The signal processing circuit delays and/or broadens the abnormal-voltage signal to generate the switch closing signal. The switch closing signal is transmitted to the isolating-driving circuit, and the isolating-driving circuit applies the turn-on voltage to the switching circuit in the voltage clamping circuit to turn on the switching circuit.

After the switching circuit is turned on, the voltage of the phase line is applied to the overvoltage suppressing circuit along the corresponding current path in the voltage clamping circuit. Since a voltage peak on the phase line is greater than the breakdown voltage of the overvoltage suppressing circuit when the transient overvoltage occurs, the overvoltage suppressing circuit bleeds the current, clamps the voltage within a predetermined range, and prevents the voltage peak from rising further.

When the transient overvoltage disappears, the voltage detecting circuit detects that the voltage returns to normal and outputs a normal-voltage signal. The voltage normal signal is transmitted to the signal processing circuit and then the isolating-driving circuit, and the corresponding switching circuit in the voltage clamping circuit is turned off according to the normal-voltage signal. After the switching circuit is turned off, the voltage of the phase line is shared between the switching circuit and the overvoltage suppressing circuit along the corresponding current path. At such time, the voltage applied to the overvoltage suppressing circuit is lower than its breakdown voltage, and hence the overvoltage suppressing circuit presents a high impedance.

In some embodiments, the AC side of the inverter circuit is connected to a power grid, the voltage of the phase line being outside the voltage range refers to a voltage of the power grid being outside the voltage range. In some embodiments, the AC side of the inverter circuit is connected to a load, the voltage of the phase line being outside the voltage range refers to an output voltage of the inverter circuit being outside the voltage range.

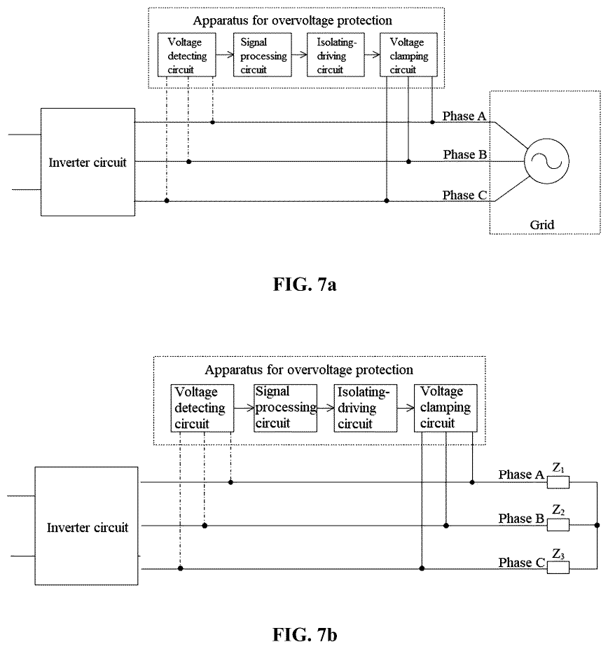

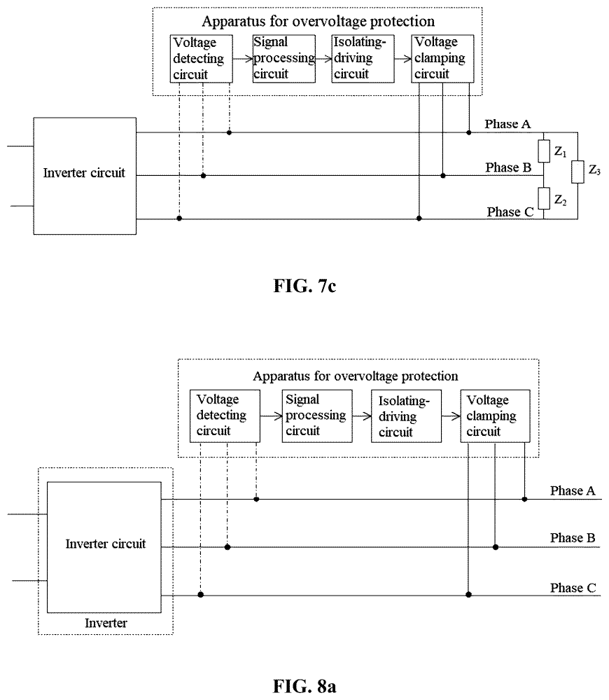

Reference is made to FIG. 7a. The AC side of the inverter circuit is connected to the power grid. The phase lines at the AC side of the inverter circuit are connected to phase lines of the power grid. When amplitude of the voltage of the power grid is outside the voltage range, the switching circuit in the voltage clamping sub-circuit connected to the phase line corresponding to such voltage is turned on.

The load may be connected to the AC side of the inverter circuit. When amplitude of the output voltage of the inverter circuit is outside the voltage range, the switching circuit in the voltage clamping sub-circuit connected to the phase line corresponding to such output voltage is turned on. Reference is made to FIG. 7b, where the load at the AC side of the inverter circuit may be connected in star connection. Resistors Z₁, Z₂, and Z₃ represent the load. Reference is made to FIG. 7c, where the load at the AC side of the inverter circuit may be connected in delta connection. The present disclosure is not limited to the above connections.

An inverter is further provided according to embodiments of the present disclosure. The inverter comprises an inverter circuit, and the AC side of the inverter circuit is connected to the apparatus for overvoltage protection in any foregoing embodiment.

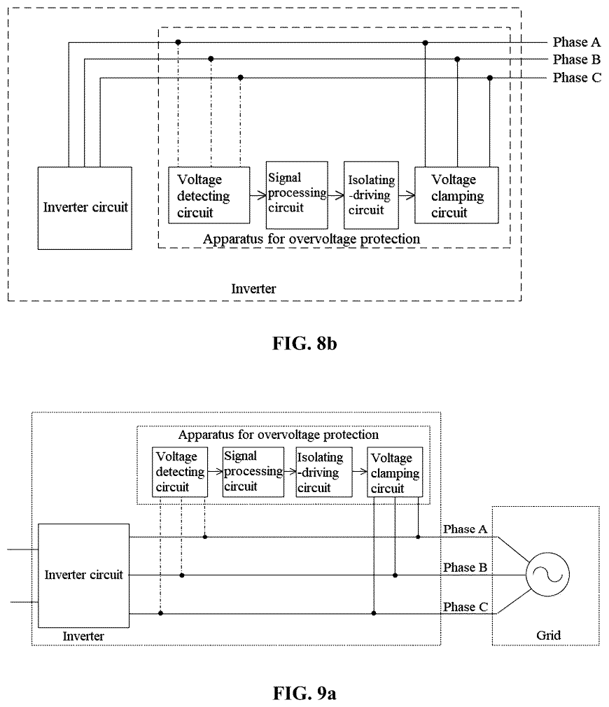

Reference is made to FIG. 8a. The apparatus for overvoltage protection may be located outside of the inverter, that is, at the AC side of the inverter. Reference is made to FIG. 8b. The apparatus for overvoltage protection may alternatively be provided inside of the inverter.

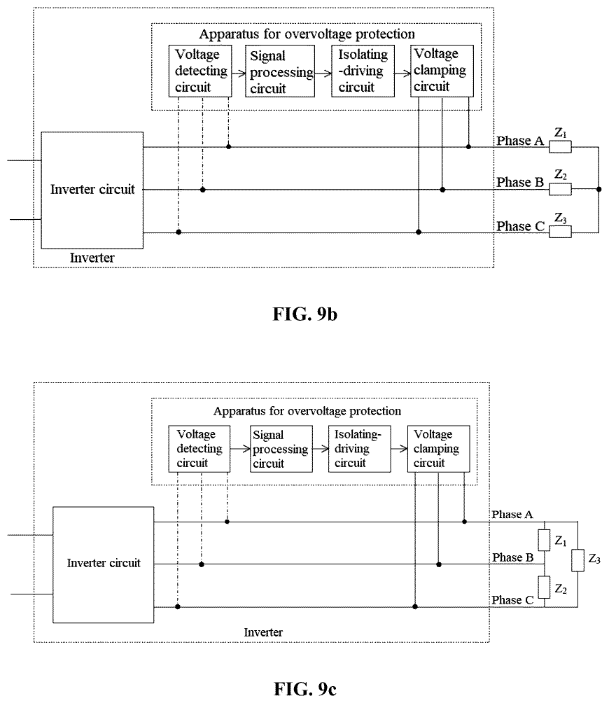

In some embodiments, the inverter may comprise the inverter circuit and the apparatus for overvoltage protection. Reference is made to FIG. 9a. The AC side of the inverter may be connected to the power grid. Reference is made to FIGS. 9b and 9c. The AC side of the inverter may be connected to a load. The load may be connected as a star connection or a delta connection. The present disclosure is not limited to the above connections.

The apparatus for overvoltage protection may be integrated inside the inverter, so that components in the inverter may be multiplexed to serve as the voltage detecting circuit and the signal processing circuit, which reduces redundant configuration of components and reduces the cost of the apparatus for overvoltage protection. In addition, the multiplexing can also reduce delays in signal transmission among systems, and hence the real-time performances and anti-interference capability of the system are improved.

A method for overvoltage protection is further provided according to embodiments of the present disclosure. The method is applicable to a voltage clamping circuit comprising a voltage clamping sub-circuit connecting a first phase line and a second phase line at an alternating-current side of an inverter circuit. The voltage clamping sub-circuit comprises an overvoltage suppressing circuit and a switching circuit. The method comprises a following step. The switching circuit is turned on to form a current path between the first phase line and the second phase line via the overvoltage suppressing circuit, in response to a voltage of a first phase line being outside a voltage range. A breakdown voltage of the overvoltage suppressing circuit is within the voltage range.

In some embodiments, turning on the switching circuit to form the current path comprises following sub-steps. An abnormal-voltage signal outputted by a voltage detecting circuit is received, where the voltage detecting circuit outputs the abnormal-voltage signal when detecting that the voltage of the first phase line is outside the voltage range. The switching circuit is turned on according to the abnormal-voltage signal.

In some embodiments, the voltage detecting circuit comprises a voltage sampling sub-circuit and a voltage comparing sub-circuit. The voltage sampling sub-circuit is configured for sampling the voltage of the first phase line with reference to a virtual neutral point and outputting the sampled voltage to the voltage comparing sub-circuit. The voltage comparing sub-circuit is configured for: comparing the sampled voltage with an upper limit and a lower limit of the voltage range, and outputting the abnormal-voltage signal in response to the sampled voltage being greater than the upper limit or lower than the lower limit.

In some embodiments, turning on the switching circuit according to the abnormal-voltage signal comprises following sub-steps. The abnormal-voltage signal is delayed and/or broadened to obtain a switch closing signal, in response to receiving an abnormal-voltage signal. The abnormal-voltage signal indicates that the voltage of the first phase line is outside the voltage range. The switching circuit is turned on according to the switch closing signal.

In some embodiments, turning on the switching circuit according to the abnormal-voltage signal comprises following sub-steps. A switch closing signal is transmitted to an input terminal of an isolating-driving circuit such that an output terminal of the isolating-driving circuit applies a turn-on voltage to the switching circuit, where the switching circuit is turned on under the turn-on voltage. The switch closing signal indicates that the voltage of the first phase line is outside the voltage range. The input terminal of the isolating-driving circuit is electrically isolated from the output terminal of the isolating-driving circuit.

In some embodiments, the isolating-driving circuit comprises an opto-isolator for isolating the input terminal and the output terminal of the isolating-driving circuit.

In some embodiments, turning on the switching circuit to form the current path comprises following sub-steps. An abnormal-voltage signal outputted by a voltage detecting circuit is received, where the voltage detecting circuit outputs the abnormal-voltage signal when detecting that the voltage of the first phase line is outside the voltage range. The abnormal-voltage signal is delayed and/or broadened to obtain a switch closing signal. The switch closing signal is transmitted to an input terminal of an isolating-driving circuit such that an output terminal of the isolating-driving circuit applies a turn-on voltage to the switching circuit, where the switching circuit is turned on under the turn-on voltage. The input terminal of the isolating-driving circuit is electrically isolated from the output terminal of the isolating-driving circuit.

In some embodiments, the voltage clamping circuit comprises multiple voltage clamping branches for multiple phase lines, respectively, and a common node. Each of the multiple voltage clamping branches connects the respective phase line of such voltage clamping branch to the common node. The voltage clamping sub-circuit comprises a common node, a first voltage clamping branch connecting the common node and the first phase line, and a second voltage clamping branch connecting the common node and the second phase line. The overvoltage suppressing circuit and the switching circuit are connected in series in the first voltage clamping branch.

In some embodiments, the voltage clamping circuit comprises multiple bridge branches for multiple phase lines, respectively, and multiple voltage clamping branches. Different ones of the multiple bridge branches connect different pairs, respectively, among the multiple voltage clamping branches. Each of the multiple voltage clamping branches connects the respective phase line of such voltage clamping branch to the multiple bridge branches. The voltage clamping sub-circuit comprises a bridge branch, a first voltage clamping branch connecting a terminal of the bridge branch and the first phase line, and a second voltage clamping branch connecting another terminal of the bridge branch and the second phase line. The bridge branch comprises the overvoltage suppressing circuit, and the first voltage clamping branch comprises the switching circuit.

In some embodiments, the switching circuit comprises an anti-parallel diode, and a forward direction of the anti-parallel diode points to the first phase line. Turning on the switching circuit to form the current path comprises a following step. The switching circuit is turned on in response to the voltage of the first phase line being greater than an upper limit of the voltage range or a voltage of the second phase line being lower being lower than a lower limit of the voltage range.

In some embodiments, the alternating-current side of the inverter circuit is connected to a power grid, and the voltage of the first phase line is a voltage of the power grid. In alternative embodiments, the alternating-current side of the inverter circuit is connected to a load, and the voltage of the first phase line is an output voltage of the inverter circuit.

In some embodiments, the overvoltage suppressing circuit comprises a varistor.

Description of the method for overvoltage protection may refer to other embodiments of the present disclosure, and details are not repeated herein.

An energy system is further provided according to embodiments of the present disclosure. The energy system comprises an inverter circuit, and an alternating-current side of the inverter circuit is connected to the apparatus for overvoltage protection according to any forgoing embodiment.

Description of the energy system may refer to other embodiments of the present disclosure, and details are not repeated herein.

The “connection” in embodiments may be construed as “electrical connection”, “communication connection”, or the like, when the connected circuits, modules, units, or the like could transmit an electrical signal or data between each other.

Specific examples illustrated herein are merely intended for helping those skilled in the art understand embodiments of the present disclosure better, and not for limiting the protection scope of the present disclosure.

Serial numbers utilized in a process in embodiments of the present disclosure do not indicate a sequence of performing the steps. The sequence shall be determined according to functions and internal logic of the steps, and no additional limitation is imposed on an implementation process of the steps.

Various embodiments described herein may be implemented individually or in combination, which is not limited herein.

Unless otherwise described, all technical and scientific terms used herein have the same meanings as commonly understood by those skilled in the art. The terms are merely intended for describing specific embodiments, rather than limiting the protection scope of the present disclosure. The term “and/or” used in the present disclosure includes any one and any combination of the related items as listed. The terms “a/an”, “such/said”, and “the” modifying a singular form of an object are intended for including a plurality of the objects, unless explicitly indicated otherwise.

The units and algorithmic steps in the examples described according to the embodiments disclosed herein may be implemented in forms of electronic hardware, computer software or the combination of both. Whether hardware or software is used to implement the functions depends on a specific application and design constraints for the technical solution. For each specific application, different methods may be used by those skilled in the art to implement the described function, and such implementation should not be considered to depart from the scope of the present disclosure.

For the sake of clarity and conciseness, specific operations of some systems, devices and methods are not described herein, and one may refer to the corresponding description in the foregoing apparatus embodiments.

The disclosed systems, devices, and methods may be implemented in other ways. For example, the embodiments of the apparatus described above are only schematic. For example, the division of the units is only a logical functional division, and there may be other division manners in practice. For example, multiple units or components may be combined or integrated into another system, or some features may be omitted or not be executed. In addition, couplings or communication connections shown or discussed may be directly or indirect couplings or communication connections implemented via some interface, apparatus, or unit, and they may be electrical, mechanical, or in other forms.

The units described as separate components may be or may be not separated physically. The component displayed as a unit may be or may be not a physical unit, that is, it may be located at one place or may be distributed among multiple network units. Some or all of the units may be selected according to actual needs to achieve objectives of solutions in embodiments.

Herein described are only specific embodiments of the present disclosure, and the protection scope of the present disclosure is not limited thereto. Changes or substitutions that can be easily made by those skilled in the art shall all fall within the protection scope of the present disclosure. Therefore, the protection scope of the present disclosure is defined by the claims.

1. An apparatus for overvoltage protection, comprising:
a voltage clamping circuit, comprising a voltage clamping sub-circuit connecting a first phase line and a second phase line at an alternating-current side of an inverter circuit, wherein:
the voltage clamping sub-circuit comprises an overvoltage suppressing circuit and a switching circuit;
the switching circuit is configured to be turned on for forming a current path between the first phase line and the second phase line via the overvoltage suppressing circuit, in response to a voltage of the first phase line being outside a voltage range; and
a breakdown voltage of the overvoltage suppressing circuit is within the voltage range.

2. The apparatus according to claim 1, further comprising:
a voltage detecting circuit, configured for detecting the voltage of the first phase line and outputting an abnormal-voltage signal in response to the voltage of the first phase line being outside the voltage range;
wherein the abnormal-voltage signal is configured for turning on the switching circuit.

3. The apparatus according to claim 2, wherein:
the voltage detecting circuit comprises a voltage sampling sub-circuit and a voltage comparing sub-circuit;
the voltage sampling sub-circuit is configured for sampling the voltage of the first phase line with reference to a virtual neutral point and outputting the sampled voltage to the voltage comparing sub-circuit;
the voltage comparing sub-circuit is configured for:
comparing the sampled voltage with an upper limit and a lower limit of the voltage range, and
outputting the abnormal-voltage signal in response to the sampled voltage being greater than the upper limit or lower than the lower limit.

4. The apparatus according to claim 1, further comprising a signal processing circuit, wherein:
an output terminal of the signal processing circuit corresponds to the switching circuit;
the signal processing circuit is configured for delaying, broadening, or both delaying and broadening the abnormal-voltage signal to obtain a switch closing signal, in response to an input terminal of the signal processing circuit receiving an abnormal-voltage signal, wherein the abnormal-voltage signal indicates that the voltage of the first phase line is outside the voltage range; and
the switch closing signal is configured for turning on the switching circuit.

5. The apparatus according to claim 1, further comprising an isolating-driving circuit corresponding to the switching circuit, wherein:
an input terminal of the isolating-driving circuit is electrically isolated from an output terminal of the isolating-driving circuit;
the isolating-driving circuit is configured for applying a turn-on voltage to the switching circuit through the output terminal of the isolating-driving circuit to turn on the switching circuit, in response to the input terminal of the isolating-driving circuit receiving a switch closing signal, wherein the switch closing signal indicates that the voltage of the first phase line is outside the voltage range.

6. The apparatus according to claim 5, wherein the isolating-driving circuit comprises an opto-isolator for isolating the input terminal and the output terminal of the isolating-driving circuit.

7. The apparatus according to claim 1, further comprising a voltage detecting circuit, a signal processing circuit, and an isolating-driving circuit, wherein:
the voltage detecting circuit is configured for:
detecting the voltage of the first phase line, and
outputting an abnormal-voltage signal for the first phase line in response to the voltage of the first phase line being outside the voltage range;
the signal processing circuit is configured for delaying, broadening, or both delaying and broadening the abnormal-voltage signal to obtain a switch closing signal; and
the isolating-driving circuit is configured for applying a turn-on voltage to the switching circuit to turn on the switching circuit, in response to receiving the switch closing signal.

8. The apparatus according to claim 1, wherein:
the voltage clamping sub-circuit comprises a common node, a first voltage clamping branch connecting the common node and the first phase line, and a second voltage clamping branch connecting the common node and the second phase line; and
the overvoltage suppressing circuit and the switching circuit are connected in series in the first voltage clamping branch.

9. The apparatus according to claim 1, wherein:
the voltage clamping sub-circuit comprises a bridge branch, a first voltage clamping branch connecting a terminal of the bridge branch and the first phase line, and a second voltage clamping branch connecting another terminal of the bridge branch and the second phase line; and
the bridge branch comprises the overvoltage suppressing circuit, and the first voltage clamping branch comprises the switching circuit.

10. The apparatus according to claim 8, wherein:
the switching circuit comprises an anti-parallel diode, and a forward direction of the anti-parallel diode points to the first phase line;
the switching circuit is configured to be turned on in response to the voltage of the first phase line being greater than an upper limit of the voltage range or a voltage of the second phase line being lower being lower than a lower limit of the voltage range.

11. The apparatus according to claim 9, wherein:
the switching circuit comprises an anti-parallel diode, and a forward direction of the anti-parallel diode points to the first phase line;
the switching circuit is configured to be turned on in response to the voltage of the first phase line being greater than an upper limit of the voltage range or a voltage of the second phase line being lower being lower than a lower limit of the voltage range.

12. The apparatus according to claim 1, wherein the overvoltage suppressing circuit comprises a varistor.

13. A method for overvoltage protection, applicable to a voltage clamping circuit comprising a voltage clamping sub-circuit connecting a first phase line and a second phase line at an alternating-current side of an inverter circuit, wherein:
the voltage clamping sub-circuit comprises an overvoltage suppressing circuit and a switching circuit;
the method comprises turning on the switching circuit to form a current path between the first phase line and the second phase line via the overvoltage suppressing circuit, in response to a voltage of a first phase line being outside a voltage range; and
a breakdown voltage of the overvoltage suppressing circuit is within the voltage range.

14. The method according to claim 13, wherein turning on the switching circuit to form the current path comprises:
receiving an abnormal-voltage signal outputted by a voltage detecting circuit, wherein the voltage detecting circuit outputs the abnormal-voltage signal when detecting that the voltage of the first phase line is outside the voltage range; and
turning on the switching circuit according to the abnormal-voltage signal.

15. The method for overvoltage protection according to claim 14, wherein:
the voltage detecting circuit comprises a voltage sampling sub-circuit and a voltage comparing sub-circuit;
the voltage sampling sub-circuit is configured for sampling the voltage of the first phase line with reference to a virtual neutral point and outputting the sampled voltage to the voltage comparing sub-circuit; and
the voltage comparing sub-circuit is configured for:
comparing the sampled voltage with an upper limit and a lower limit of the voltage range, and
outputting the abnormal-voltage signal in response to the sampled voltage being greater than the upper limit or lower than the lower limit.

16. The method according to claim 13, wherein turning on the switching circuit to form the current path comprises:
delaying, broadening, or both delaying and broadening the abnormal-voltage signal to obtain a switch closing signal, in response to receiving an abnormal-voltage signal, wherein the abnormal-voltage signal indicates that the voltage of the first phase line is outside the voltage range; and
turning on the switching circuit according to the switch closing signal.

17. The method according to claim 13, wherein turning on the switching circuit to form the current path comprises:
transmitting a switch closing signal to an input terminal of an isolating-driving circuit to enable an output terminal of the isolating-driving circuit to apply a turn-on voltage to the switching circuit, wherein:
the switch closing signal indicates that the voltage of the first phase line is outside the voltage range, the switching circuit is turned on under the turn-on voltage, and the input terminal of the isolating-driving circuit is electrically isolated from the output terminal of the isolating-driving circuit.

18. The method according to claim 13, wherein turning on the switching circuit to form the current path comprises:
receiving an abnormal-voltage signal outputted by a voltage detecting circuit, wherein the voltage detecting circuit outputs the abnormal-voltage signal when detecting that the voltage of the first phase line is outside the voltage range;
delaying, broadening, or both delaying and broadening the abnormal-voltage signal to obtain a switch closing signal; and
transmitting the switch closing signal to an input terminal of an isolating-driving circuit to enable an output terminal of the isolating-driving circuit to apply a turn-on voltage to the switching circuit, wherein the switching circuit is turned on under the turn-on voltage, and the input terminal of the isolating-driving circuit is electrically isolated from the output terminal of the isolating-driving circuit.

19. The method according to claim 13, wherein the overvoltage suppressing circuit comprises a varistor.

20. An inverter, comprising an inverter circuit, wherein an alternating-current side of the inverter circuit is connected to an apparatus for overvoltage protection, and the apparatus comprises:
a voltage clamping circuit, comprising a voltage clamping sub-circuit connecting a first phase line and a second phase line at an alternating-current side of the inverter circuit, wherein:
a voltage clamping sub-circuit comprises an overvoltage suppressing circuit and a switching circuit;
the switching circuit is configured to be turned on for forming a current path between the first phase line and the second phase line via the overvoltage suppressing circuit, in response to a voltage of the first phase line being outside a voltage range; and
a breakdown voltage of the overvoltage suppressing circuit is within the voltage range.
